(19) United States
(12) Patent Application Publication
(10) Pub. No.: US 2005/0207675 A1
(43) Pub. Date: Sep. 22, 2005

(54) Image processing apparatus

(75) Inventors: Takahiro Fuchigami, Yokosuka-shi (JP); Shunichi Megawa, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/805,278

(22) Filed: Mar. 22, 2004

(51) Int. Cl. G06K 9/32; H04N 1/40

(52) U.S. Cl. 382/298; 358/3.24

(57) ABSTRACT

One or more rectangular regions including image objects are extracted from input document image. The input document image is reduced by a desired scale factor, and the extracted rectangular regions are varied in scale by scale factors greater than the desired scale factor. The input document image varied in scale by the desired scale factor and the rectangular region images varied in scale are synthesized and outputted.

### BACKGROUND OF THE INVENTION

The present invention relates to an image processing apparatus which is applied to an image forming apparatus such as a scanner that reads a document image such as a document, a copying machine that copies a document image on a paper, or the like, and which processes the read document image.

Generally, a scanner that reads a document image has a first carriage having a light source and a first mirror, a second carriage having second and third mirrors, a lens and a CCD, etc. When a document is read by the scanner, the document placed on a document glass plate is illuminated by the light source of the first carriage that moves in the sub-scanning direction. Reflected light from the document is reflected on the first to third mirrors, and is concentrated by the lens and guided to the CCD sensor. At that time, the second carriage moves such that an optical path length of the reflected light from the document to the CCD is constant, in a direction which is the same as the moving direction of the first carriage and at a half-speed of that of the first carriage. The CCD sensor scans the incident reflected light in the main scanning direction. As a result, a document image of one scanning line is converted into an electric signal. By scanning the document in the sub-scanning direction by using the first and second carriages, image data corresponding to the entire range of the document image is provided from the CCD sensor.

When the document is copied by using the image forming apparatus, the document image is read by the scanner unit as described above, and at a printer unit, an electrostatic latent image is formed on a photosensitive drum by using an optical beam which emits light in accordance with image data. A toner is adhered to the electrostatic latent image by a developing machine, and a toner image is formed. The toner image is transferred onto a paper by a transfer unit, and is fixed on the paper at a fixing unit. In this way, a copy image is printed on the paper.

Conventionally, when a document image is varied in scale (enlarged or reduced) and is copied onto a paper sheet, generally, the variable scale-factor processing is carried out by designating a uniform scale factor of the entire document image.

When the document image is reduced and copied by a conventional image forming apparatus, there are cases in which characters included in the document image are made to be too small, and thus are hard to read.

### SUMMARY OF THE INVENTION

An object of the present invention is to prevent text from being made to hard to read, for example, when a document is reduced and copied.

In order to achieve the above object, according to one aspect of the present invention, there is provided an image processing apparatus comprising: an image input unit which inputs image data corresponding to a document image as an input document image; a first variable scale-factor unit which varies the input document image by a desired scale factor; a division unit which divides the input document image into one or more regions; a scale-factor designating unit which designates scale factor of an image at one of the regions divided by the division unit to scale factor different from that of the first variable scale-factor unit; a second variable scale-factor unit which varies the image at the one of the divided regions by the scale factor designated by the scale-factor designating unit; and a synthesis unit which synthesizes the input document image varied in scale by the first variable scale-factor unit and the image varied in scale by the second variable scale-factor unit.

### BRIEF DESCRIPTION OF THE DRAWINGS

FIG. 1 illustrates one example of an image processing block diagram of a digital copying machine to which the present invention is applied.

FIG. 2 illustrates one example of a flowchart showing processings of a processor according to a first embodiment of the present invention.

FIGS. 3A and 3B illustrate one example of processed results of layout analysis processing.

FIG. 4 illustrates one example of a display panel for use in allocation processing.

FIG. 5 is a diagram for explanation of a concept of variable scale-factor processing due to a change of distances between character strings.

FIG. 6 illustrates one example of a flowchart showing another layout analysis processing.

FIG. 7 is a diagram for explanation of a concept of character extraction processing.

### DETAILED DESCRIPTION OF THE PREFERRED EMBODIMENTS

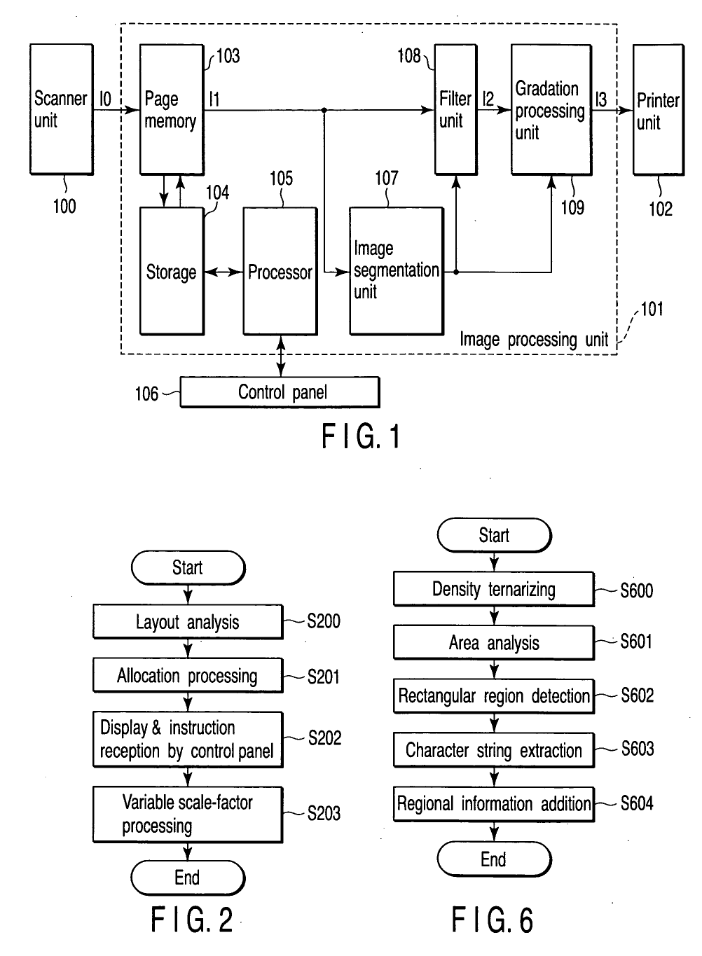

FIG. 1 illustrates one example of an image processing block diagram of a digital copying machine to which the present invention is applied.

A document is optically read at a scanner unit 100, and the obtained image signal is analog-to-digital converted to generate digital image data. Processings are appropriately carried out on the generated image data at an image processing unit 101, and an image is formed onto a paper sheet by a toner or in ink at the printer unit 102, whereby the copying is completed.

In the image processing unit 101, first, input image data is housed in a page memory 103 under the control of a processor 105. The page memory 103 is composed of, for example, an SDRAM or the like, and an ASIC for controlling the SDRAM, and an image compressing/expanding ASIC etc., and has a capacity such that the image data on the entire document can be stored. The housed image data is transmitted to a storage (hard disk or the like) 104 as needed, and variable scale-factor processing and allocation processing (which will be described later), etc. corresponding to the operated results at a control panel 106 are carried out thereon by the processor 105. Image data on which the processings have been carried out are inputted, via the storage 104 and the page memory 103 again, to an image segmentation unit 107 and a filter unit 108.

At the image segmentation unit 107, processing of extracting portions of characters or line drawings in the input image is carried out by using an edge detection filter such as a Sobel filter, and switching of a character emphasizing filter and a smoothing filter, or the like is carried out at the filter unit 108 in accordance with the result. The image data on which filter processing has been carried out is inputted to a tone processing unit 109, and gamma correction processing, screen processing, or the like which corresponds to the characteristic of the printer unit 102 is carried out.

FIG. 2 is a flowchart showing processings of the processor 105 according to a first embodiment of the present invention. In the present embodiment, the present invention will be described by using, as an example, processing in which a plurality of document images are reduced, and are synthesized into one document image.

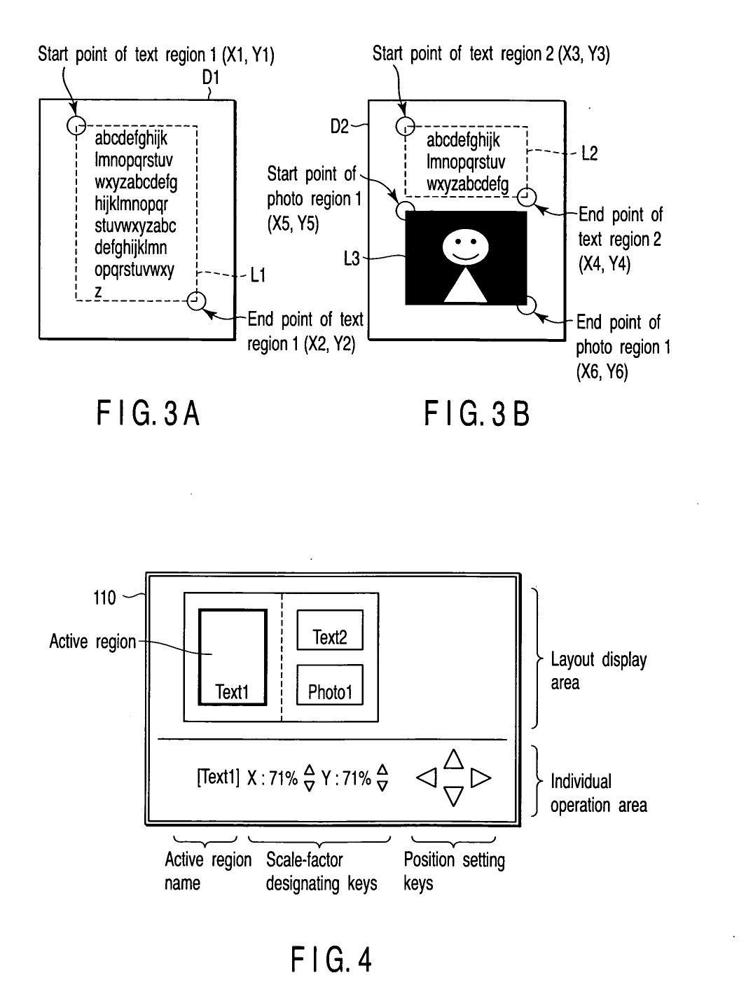

First, in step S200, a layout analysis for each document image for use in the allocation processing which will be described later is carried out on the basis of the image data accumulated in the storage 104. Specifically, with respect to each document image, one or more rectangular regions each including an image object are extracted (in other words, the document image is divided), and the coordinates of the vertices of each rectangular region (the start point and the end point of scanning) are determined. FIG. 3 is one example of processed results of the layout analysis processing. At a document image D1, a rectangular region including an image object (hereinafter, simply called a rectangular region) L1 is extracted, and the start point (X1, Y1) and the end point (X2, Y2) are determined. At a document image D2, rectangular regions L2 and L3 are extracted, and the start point (X3, Y3) and the end point (X4, Y4) of the rectangular region L2, and the start point (X5, Y5) and the end point (X6, Y6) of the rectangular region L3 are determined. Note that, the regions L1 and L2 are text regions including character objects, and the region L3 is a photo region including a photographic object. Further, as another embodiment, merely a reduced image of the document is displayed, and a user may manually carry out such an extraction of a rectangular region by using the control panel 106 on the basis of the display.

In step S201, with reference to the vertex coordinate information of the respective rectangular regions determined in step S200, processing, such as “2-in-1”, or “4-in-1”, is carried out in which a plurality of document images are allocated into the respective regions in a single output image. The 2-in-1 means processing in which two document images are allocated (synthesized) into one output image, and the 4-in-1 means processing in which four document images are allocated into one output image. However, at this stage, merely positionings of the respective rectangular regions are carried out, and actual allocations of image data are not carried out.

In step S202, as shown in FIG. 4, the result of the allocation processing in step S201 is displayed on the control panel or the like. Instructions from the user on the basis of the display are received, and a re-allocation and a re-display are carried out every time of receiving an instruction. At a display screen 110 in FIG. 4, a layout display area showing an image layout and an individual operation area showing operation keys or the like are provided.

FIG. 4 illustrates an example in which, for example, two A4 sized documents are reduced and allocated into the respective regions in one A4 sized document. In other word, two A4 sized documents are reduced and synthesized into one A4 sized document. Accordingly, a desired enlargement factor of the entire document image is 71%. Note that, an enlargement factor of all of the plurality of document images to be allocated may be arbitrarily set by using the control panel including a display unit as shown in FIG. 4. Further, the enlargement factors of the plurality of document images to be allocated in this way may be set to values different from one another. Moreover, as another embodiment, it suffices that the extraction of the rectangular regions or the division of the region are not carried out, but merely, scale factors of the respective document images to be allocated may be individually set.

At the individual operation area, a region name of the region which is currently active, scale-factor designating keys, and position setting keys are provided. The user can select one of the rectangles displayed on the layout display area by the position setting keys. The selected rectangular region is shown as an active region by, for example, a thick closing line, and the region name thereof is displayed as an active region name. The user can designate a scale factor of the active region by the scale factor designating keys. A size of the active region displayed on the layout display area is changed in accordance with the designated scale factor. Every time of changing designation of the scale factor, the size of the active region is changed.

Here, in order to make such an operation possible, it is necessary to set such that the rectangular regions in the default layout are entirely covered with rectangular regions corresponding thereto in a layout after changing. Specifically, it is necessary that the scale factor of the target rectangular region is greater than or equal to the scale factor of the entire document. For example, when the enlargement factor of the entire document is 71%, it is necessary that the enlargement factor of the target rectangular region is greater than or equal to 71%.

At a region at which the document image and the rectangular region varied in scale are overlapped, only the image data of the rectangular region is available. The widths of the overlapped regions are set so as to be uniform at the periphery of the rectangular region. However, the widths of the overlapped regions can be set so as to be asymmetrical on the left and right, or top and bottom at the rectangular region, by changing the position of the rectangular region via the control panel.

When the user presses an execution button (not shown) down, variable scale-factor processing is carried out as in step S203. Specifically, according to the layout as shown in the layout display area in FIG. 4, there are carried out variable scale factor processing of the entire respective document images, allocation of the document image data varied in scale, variable scale factor processing for each rectangular region, and allocation of the rectangular region data to the document image varied in scale. In short, the document images varied in scale and the rectangular regions varied in scale are synthesized. In this way, the plurality of document images are synthesized into one document image.

Note that, in the above description, the example is shown in which the present invention is applied to the case in which the document image is reduced. However, the present invention is not limited to the case of reduction, but can be applied to a case of equal scale (multiple=1) as well. In that case, the scale factor of the extracted rectangular region is set to a value greater than or equal to 1. In accordance therewith, only the text whose characters are too small to read in the document are enlarged in a copy.

Next, another embodiment relating to the variable scale-factor processing on rectangular regions will be described.

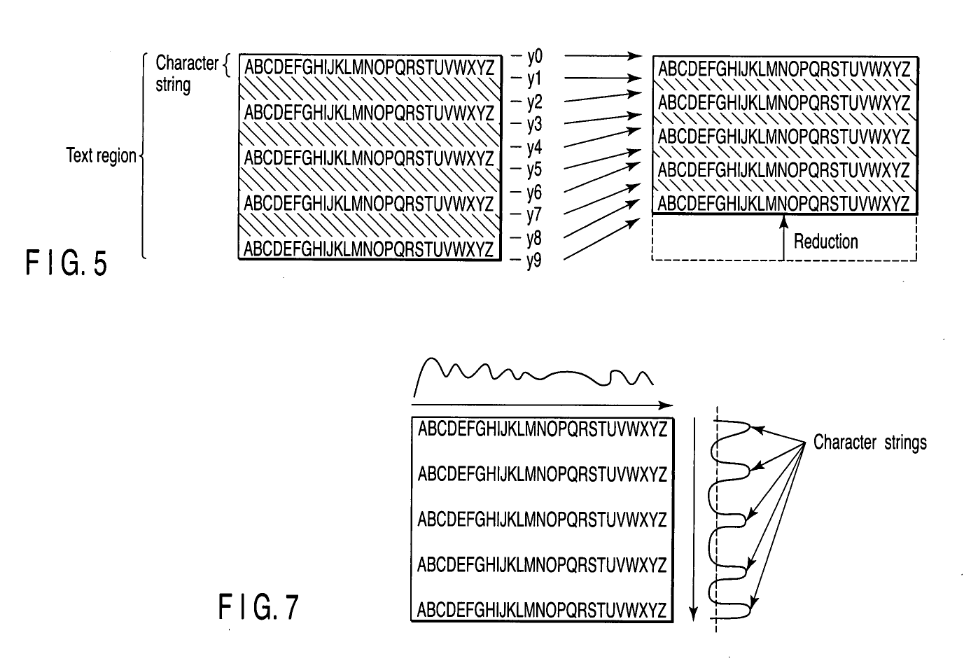

The variable scale-factor processing onto a text region is not only carried out such that a region size is uniformly varied in scale, but also as shown in FIG. 5, only the space between a character string and a character string which have been extracted can be varied in scale. Specifically, with only the longitudinal direction of non-character string regions (the coordinates are y2-y1, y4-y3, . . . ) shown by the shaded areas in FIG. 5 being an object for variable scale-factor processing, the variable scale-factor processing can be carried out by converting the document scale factor Rorg into an actual scale factor R as the following formula (1):
R={Ymax×Rorg−Σ(y(2n+1)−y(2n))}/{Ymax−Σ(y(2n+1)−y(2n))} (1)
where, Ymax is a variable scale-factor object direction size of a text region, n is an integer greater than or equal to 0, and y(2n) and y(2n+1) respectively express the start point and the end point of a character string region.

Here, various methods can be used as a method for extracting character strings, and as an example, there can be provided a method including the layout analysis processing in step 200 as will be described hereinafter.

FIG. 6 is one example of a flowchart showing layout analysis processing by the processor 105 according to the present embodiment.

First, in step S600, the respective pixels of the input image are ternarized on the basis of the densities, and are classified into a grounding region, a character region, and a halftone region. In step S601, at the character region, a region of a size greater than or equal to a predetermined area is re-classified to the halftone region. In step S602, remaining pixels at the character region are enclosed by a rectangle, which is made to serve as a text region, so that a distance between adjacent pixels at the character region is a predetermined value or less. In the same way, the halftone region is enclosed by a rectangle, and this is made to serve as a photo region. Note that, the details of the layout analysis processing in which various regions are identified are disclosed in, for example, Jpn. Pat. Appln. KOKAI Publication No. 11-69150.

In step S603, in the text region, as shown in FIG. 7, character region pixels are projected respectively in the transverse direction and the longitudinal direction, and a histogram (pixel frequency distribution) is generated. With respect to the direction (the longitudinal direction in the drawing) in which a difference between a maximum value and a minimum value in the histogram is large, and a space between the maximum points is broad, the character strings are detected by binarizing the frequency. In step S604, the coordinates of the start points and the end points, in the scanning direction, of the respective rectangular regions (text regions, photo regions, or the like), and the coordinates of the start point and the end point in the character string direction in the region and of the detected character string region, with respect to the text region, are respectively added as data to the image data. In this way, the layout analysis including the character string extraction is carried out.

As described above, in accordance with the present invention, when a document is varied in scale and copied, by varying the scale factor of a text region at a scale factor different from that of the entire document, the text can be prevented from being hard to read.

The above description is the embodiment of the present invention, and the apparatus and the method of the present invention are not limited thereto, and various modified examples can be implemented. Such modified examples are included in the present invention. Further, apparatuses or methods which are configured by appropriately combining the components, the functions, the features, or the steps of the method in the respective embodiments are included in the present invention.

For example, in the above description, there is shown the example in which the present invention is applied to the reduction and synthesis processings of a plurality of document images, such as 2-in-1 processing. However, it is clear that the present invention can be applied to reduction processing, equal-scale processing, or enlargement processing of a single document image. Further, in the above description, there is described the processing in which the scale factor of a text region is set to a value different from that of the other regions. However, it goes without saying that the scale factor of a photo region can be set to a value different from that of the other regions.

1. An image processing apparatus comprising:
an image input unit which inputs image data corresponding to a document image as an input document image;
a first variable scale-factor unit which varies the input document image by a desired scale factor;
a division unit which divides the input document image into one or more regions;
a scale-factor designating unit which designates scale factor of an image at one of the regions divided by the division unit to scale factor different from that of the first variable scale-factor unit;
a second variable scale-factor unit which varies the image at the one of the divided regions by the scale factor designated by the scale-factor designating unit; and
a synthesis unit which synthesizes the input document image varied in scale by the first variable scale-factor unit and the image varied in scale by the second variable scale-factor unit.

2. An image processing apparatus according to claim 1, wherein
the division unit includes an extraction unit which extracts one or more regions including objects from the input document image, and
the scale-factor designating unit includes a display unit which displays the regions extracted by the extraction unit and a designation portion which designates scale factor with respect to one of the displayed regions.

3. An image processing apparatus according to claim 1, further comprising an allocation unit which allocates a plurality of input document images to one region in a document image, wherein
the division unit, the scale-factor designating unit, the first and second variable scale-factor units, and the synthesis unit respectively carry out processings corresponding thereto with respect to said plurality of input document images.

4. An image processing apparatus according to claim 1, wherein the first variable scale-factor unit varies the input document image by a scale factor of 1 or less, and the second variable scale-factor unit applies a scale factor greater than the scale factor which the first variable scale-factor unit applies, to the image of the one of the divided regions.

5. An image processing apparatus according to claim 3, wherein the scale factors of the plurality of input document images to be allocated are set to values different from one another.

6. An image processing method comprising the steps of:
inputting image data corresponding to a document image as an input document image;
varying the input document image by a desired scale factor;
dividing the input document image into one or more regions;
designating scale a factor of an image at one of the divided regions to scale factor different from the desired scale factor;
varying the image at the one of the divided regions by the designated scale factor; and
synthesizing the input document image varied in scale by the desired scale factor and the image varied in scale by the designated scale factor.

7. An image processing method according to claim 6, wherein the step of dividing includes a step of extracting one or more regions including objects from the input document image, and
the step of designating the scale factor includes a step of displaying the extracted regions and a step of designating scale factor with respect to one of the displayed regions.

8. An image processing method according to claim 6, further comprising a step of allocating a plurality of input document images to one region in a document image, wherein
the step of varying the input image in scale, the step of dividing, the step of designating, the step of varying image at the one of the regions in scale, and the step of synthesizing are respectively carried out with respect to said plurality of input document images.

9. An image forming apparatus comprising:
an image reading unit which reads a document image, and which provides image data corresponding to the document image as an input document image;
a first variable scale-factor unit which varies the input document image provided from the image reading unit by a desired scale factor;
a division unit which divides the input document image into one or more regions;
a scale-factor designating unit which designates scale factor of an image at one of the regions divided by the division unit to scale factor different from that of the first variable scale-factor unit;
a second variable scale-factor unit which varies the image at the one of the divided regions by the scale factor designated by the scale-factor designating unit;
a synthesis unit which synthesizes the input document image varied in scale by the first variable scale-factor unit and the image varied in scale by the second variable-scale-factor unit; and
an image forming unit which forms an image corresponding to the image synthesized by the synthesis unit, on a paper.

10. An image forming apparatus according to claim 9, wherein
the division unit includes an extraction unit which extracts one or more regions including objects from the input document image, and
the scale-factor designating unit includes a display unit which displays the regions extracted by the extraction unit and a designation portion which designates scale factors with respect to one of the displayed regions.
